(19) United States
(12) Patent Application Publication
(10) Pub. No.: US 2016/0010844 A1
(43) Pub. Date: Jan. 14, 2016

(54) ILLUMINABLE RECEPTACLES

(71) Applicant: SLIS, Inc., Darien, IL (US)

(72) Inventor: JIADONG MA, Darien, IL (US)

(73) Assignee: SLIS, Inc.

(21) Appl. No.: 14/853,430

(22) Filed: Sep. 14, 2015

(51) Int. Cl. F21V 33/00; F21V 21/40; F21V 23/00; F21V 23/04

(52) U.S. Cl. CPC F21V 33/0004; F21V 23/0414; F21V 21/406; F21V 23/002; F21W 2111/10

(57) ABSTRACT

An illuminable receptacle may generally include a container with a handle for carrying candy or other objects, as well as at least one light source secured to a sidewall of the container. The light source may be configured to emit light primarily downwards and inwards for purposes of illuminating an inside cavity and a base of the container, and/or candy or other objects supported by the base of the container. To enhance the illumination, the light source may be located closer to an upper end of the container than a lower end of the container. Further, the light source may be substantially flush with an inner face of the sidewall so as not to obstruct access to the inside cavity of the container. Finally, the light source may be powered by a power source, which can be controlled by a power switch.

### FIELD OF THE DISCLOSURE

The present disclosure relates generally to illuminable or illuminated receptacles, such as buckets or containers, and, more particularly, to receptacles that can selectively illuminate contents of the containers.

### BACKGROUND OF RELATED ART

People often use receptacles such as buckets to collect candy, snacks, and other objects around holiday times and other occasions. One example activity for which such receptacles are used is trick-or-treating, which has for many years been a popular activity enjoyed by children at Halloween. Oftentimes children use the receptacles to collect objects at nighttime when there is little or no light. In such conditions, a child crossing a street may be in danger of not being seen by an oncoming motorist. Likewise, children typically cannot see the contents of the receptacles in which the objects are collected at nighttime. Other examples where people may use such containers include Easter egg hunts, scavenger hunts, bar crawls, and so on. Another drawback of using these receptacles in low-light conditions is that any decorative appearance of the receptacles cannot be seen. Due to these and other considerations, there is a need to improve receptacles used by children for collecting candy, snacks, and other objects.

There have been prior attempts to improve such receptacles, many of which have focused on illuminating portions of the receptacles or illuminating an area beneath the receptacles. At least one such attempt involves an extravagant double-walled container having a plurality of LEDs embedded between the first and second sidewalls, such as in U.S. Pat. No. 8,579,459. Such a container is relatively expensive to manufacture, requires an inordinate amount of material, and is not aesthetically pleasing due to the LEDs disposed haphazardly around the sidewalls of the container. Other attempts have focused on illuminating an area beneath the receptacle, which in many cases does not increase the visibility of the person holding the receptacle, such as in U.S. Pat. Nos. 4,698,732; 6,270,233; and 1,183,268. Nor does such structure illuminate the contents of the receptacle. Still other attempts involve positioning a light near a base of the receptacle so as to illuminate a portion of the receptacle, such as in U.S. Pat. No. 6,224,234. Such receptacles, however, do not illuminate the contents of the receptacle, and the visibility of such receptacles is marginal because objects deposited in the receptacle may obstruct a substantial portion of the light emitted upwards from the base of the receptacle. When the receptacle is not loaded or is lightly loaded, these receptacles can interfere with one's eyesight as light from those light sources is typically emitted upwards into the eyes of the holder.

Another known receptacle, such as in U.S. Pat. No. 5,984,751, involves a light source that is configured vertically through a center of the receptacle. One example drawback of this design is that the light source, if tall enough to illuminate the contents of the receptacle, obstructs access into and generally within the receptacle. Conversely, if the light source is short and does not obstruct access into and within the receptacle, the light source will not illuminate the contents of the receptacle. Yet another known receptacle, such as in U.S. Pat. No. 4,802,071, has an opening positioned along a rear sidewall and a light source positioned beneath a top of the receptacle. Some of the problems with this receptacle are that the light source obstructs access into and within the receptacle and that the receptacle can only be partially filled because the opening is positioned along the rear sidewall.

### BRIEF DESCRIPTION OF THE DRAWINGS

FIG. 1 is a perspective top view of an example illuminable receptacle.

FIG. 2 is a perspective bottom view of an example illuminable receptacle.

FIG. 3 is an exploded perspective view of an example illuminable receptacle.

FIG. 4 is an exploded top view of an example illuminable receptacle.

FIG. 5 is an exploded view of an example housing and an example power source for use in connection with an illuminable receptacle.

FIG. 6 is a perspective bottom view of an example illuminable receptacle having the housing and the power source shown in FIG. 5.

FIG. 7 is a perspective top view of an example cover plate that can be disposed within a rim of an illuminable receptacle.

FIG. 8 is a perspective view of an example light source to be used in connection with an illuminable receptacle.

FIG. 9 is an exploded perspective view of a plurality of lights, example shields, and an example housing for a power source that may be secured generally beneath the rim and the cover plate of a container of an illuminable receptacle.

FIG. 10 is perspective side view of the example housing of FIG. 9.

FIG. 11 is an exploded perspective view showing in the context of an example container a subassembly comprising the plurality of lights, the example shields, and the example housing for a power source shown in FIG. 9.

### DETAILED DESCRIPTION

The following description of an example apparatus is not intended to limit the scope to the precise form or forms detailed herein. Instead the following description is intended to be illustrative so that others may follow its teachings.

According to some examples, an illuminable receptacle for carrying candy or other objects may include a container having a single-layered sidewall that extends between upper and lower ends of the container. The container may have a base disposed towards the lower end for supporting objects deposited in the container and an opening and a rim approximate the upper end of the container to enable access to an inside cavity of the container. The illuminable receptacle may further include a handle secured to the upper end of the container, in some cases at one, two, or more attachment points.

The illuminable receptacle may also include at least one light source secured to the sidewall of the container. In some cases, the light source may be located closer to the upper end of the container than to the lower end of the container. Placing the light source relatively high on the sidewall enables the light source to illuminate the inside cavity and the base of the container, as well as any objects deposited within the container and supported by the base. The light source may be configured to emit light primarily inwards towards the inside cavity and downwards towards the base of the container. That said, the light source may sit flush or substantially flush with an inner face of the sidewall so as not to obstruct access to the inside cavity of the container. Moreover, in one example where two light sources are used, the light sources may be positioned across the container from one another.

Furthermore, the illuminable receptacle may also include a power source for supplying power to the light source or a light of the light source. The power source may be electrically and operably coupled to a light of the light source by a conducting wire. The power source may be controlled by a power switch operably coupled to the power source. The power source and power switch may be concealed or substantially concealed by a cover plate that in some cases is integral with and extends downwards from the rim below one of the points of attachment where the handle is secured to the container. Still further, a conducting wire coupling the power source and the light may be positioned within or generally approximate the rim of the container. In some examples, a shield may be positioned within at least a portion of the rim to conceal and protect the conducting wire. Thus, the shield may extend generally between the power source and the light source. If more than one light source is used, more than one shield may also be used.

Those having ordinary skill in the art will appreciate that there are many ways in which the light source may be secured to the sidewall. In one example, the light source may be secured in a perforation in the sidewall. In particular, the light source may include an inner portion and an outer portion. Cross sections of the inner portion and the outer portion may be larger than a cross section of the perforation in the sidewall such that the sidewall must elastically deform when the inner portion is inserted through the perforation. Once in place, the inner portion of the light source may rest against the inner face of the sidewall while the outer portion of the light source may rest against the outer face of the sidewall. In some cases the light source may also include a brim that serves a number of purposes. Amongst other things, the brim may help protect the light in the light source, help direct light from the light in the light source downwards towards the base and the inside cavity of the container, and may help reduce an amount of light that projects upwards from the light so as not to inhibit a user's vision. Still further, the light source may in one example be secured to the sidewall in a way that a portion of the light emitted from the light in the light source illuminates the outer face of the sidewall.

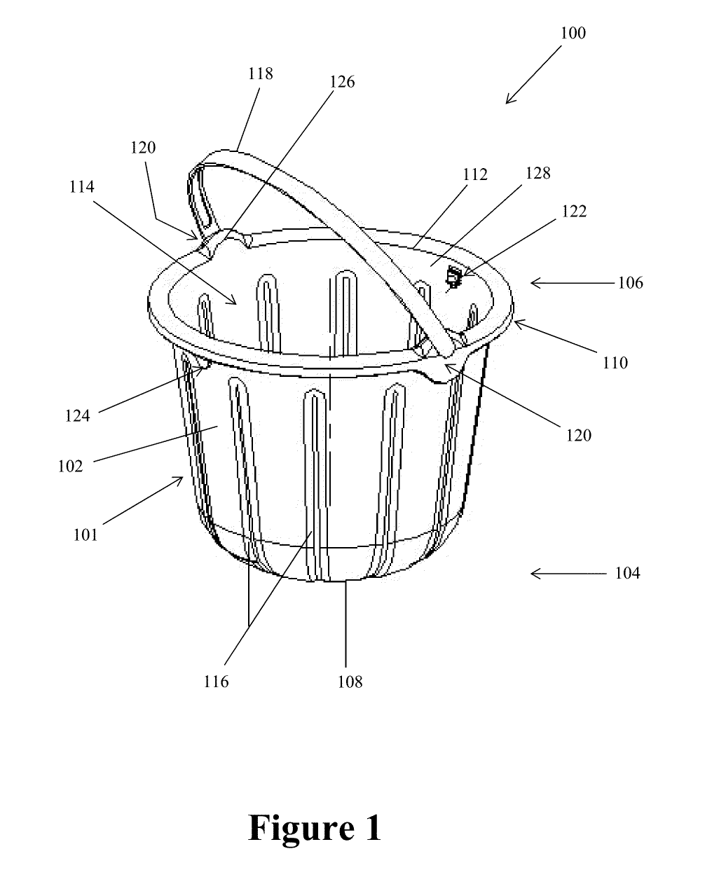

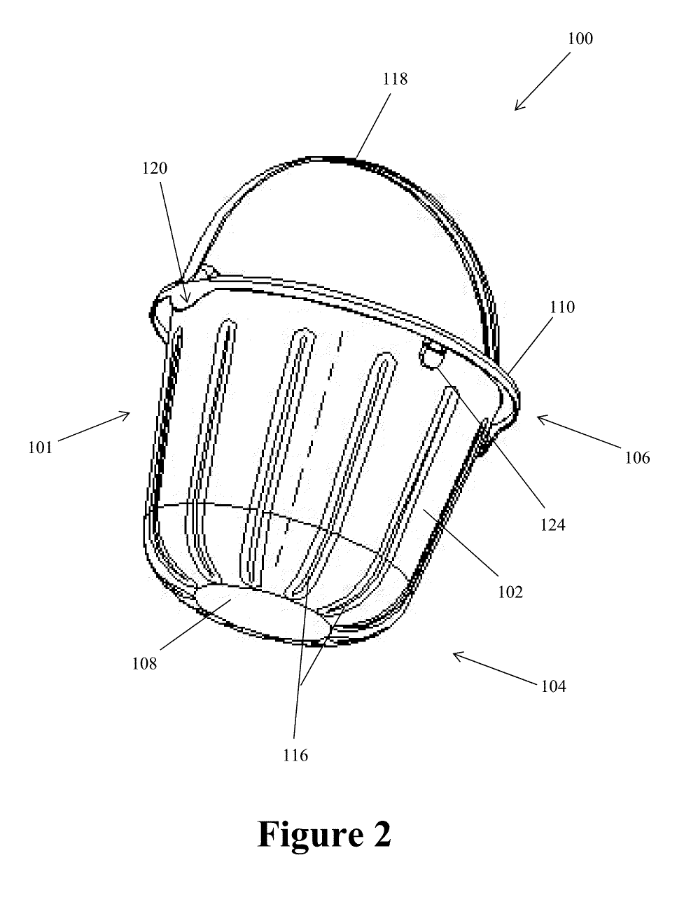

Referring now to FIGS. 1 and 2, an example of an illuminable receptacle 100 is shown. It should be understood that the example illuminable receptacle 100 may also be referred to as a “pail,” a “container,” a “bucket,” and/or the like. In some instances, the example illuminable receptacle 100 may generally include a container 101 having a sidewall 102 extending between a lower end 104 and an upper end 106, a base 108 disposed towards the lower end 104, a rim 110 disposed approximate the upper end 106, and an opening 112 approximate the upper end 106 that provides access to an inside cavity 114 of the container 101. The sidewall 102 may be single layered. Further, the rim 110 disposed at the opening 112 may take on a variety of shapes and sizes. For example, in one case the rim 110 may be rounded, while in another case the rim 110 may be rectangular. Moreover, in some examples, the sidewall 102 may include a plurality of grooves 116. The grooves 116 may enhance the appearance of the container 101 depending on the purpose of the illuminable receptacle 100. Likewise, the grooves 116 may also enhance the rigidity of the container 101 and enable multiple receptacles to be stacked in a more orderly fashion. Conversely, in other examples, the sidewall 102 does not include the grooves 116.

The illuminable receptacle 100 may be formed from a variety of materials in a variety of ways. In some examples, the illuminable receptacle 100 may be formed of plastic using one or more of the following example techniques: injection molding, extrusion molding, vacuum forming, and/or compression molding. It should be understood, though, that not necessarily all of the components of the illuminable receptacle 100 are formed from the same material through the same technique. Likewise, some of the components of the illuminable receptacle 100 may be assembled in different manufacturing stages.

The example illuminable receptacle 100 may further include a handle 118 that is secured to the upper end 106 at at least two attachment points 120. The handle 118 may be secured to the attachment points 120 by any known technique. For example, the handle 118 may include protrusions that can be pressed into apertures in the attachment points 120. A cross-section of the protrusions may be slightly larger than a cross-section of the apertures so that the apertures retain the protrusions after being slightly elastically deformed when the protrusions are pressed into the apertures. As shown in FIG. 1, each of the example attachment points 120 may include a raised portion 126 that is integral with the rim 110, but extends above the rim 110. Those having ordinary skill in the art will recognize that in other examples, the attachment points 120 need not necessarily have the raised portion 126. In other words, the attachment points 120 may be located along the rim 110 without the raised portion 126 extending upwards relative to the rim 110.

Furthermore, the illuminable receptacle 100 may also include a first light source 122 and a second light source 124 that can be turned on and off, either individually or in a combined manner, to illuminate the sidewall 102, the inside cavity 114 generally, the base 108, and/or any contents deposited within the container 101. The light sources 122, 124 may be configured to illuminate the contents of the container 101 by positioning the light sources 122, 124 at locations that are closer to the upper end 106 than to the lower end 104 of the container 101 and by orienting the light sources 122, 124 to project light downwards. In some cases, the light sources 122, 124 may be configured to emit light primarily downwards and inwards towards the inside cavity 114 and the base 108 of the container 101. Likewise, in some cases the first and second light sources 122, 124 may be positioned generally opposite one another in relation to the container 101. In other words, the light sources 122, 124 may in some cases be positioned across from one another along the sidewall 102 of the container 101.

As described below, the light sources 122, 124 may be flush with or substantially flush with an inner face 128 of the sidewall 102 so as not to obstruct access to the inside cavity 114 of the container 101. In one example, light sources may be positioned closer to and/or generally aligned with the attachment points 120 where the handle 118 is secured to the upper end 106 of the container 101. As a result, the light sources may be less likely to obstruct access to the inside cavity 114 of the container 101 because users naturally access the inside cavity 114 of the container 101 at locations where the handle 118 does not obstruct access.

In some instances, the illuminable receptacle 100 may have a different number of light sources, such as one, three, four, or more light sources, for example and without limitation. In some cases, the light sources may be spaced equidistant from one another along the sidewall 102. In other cases, however, it may be advantageous to group two or more of the light sources to cause a desired lighting effect. The light sources 122, 124 may be chosen based at least in part on the color of light emitted. As an example, the light sources 122, 124 may be configured to emit orange light when the illuminable receptacle 100 is used for purposes of trick-or-treating at Halloween. The light sources 122, 124 may also be capable of emitting light in a number of different modes. As merely examples, a first mode may cause the light sources 122, 124 to emit a slow strobe light; a second mode may cause the light sources 122, 124 to emit a fast strobe light; a third mode may cause the light sources 122, 124 to constantly emit light; and a fourth mode may cause the light sources 122, 124 not to emit any light.

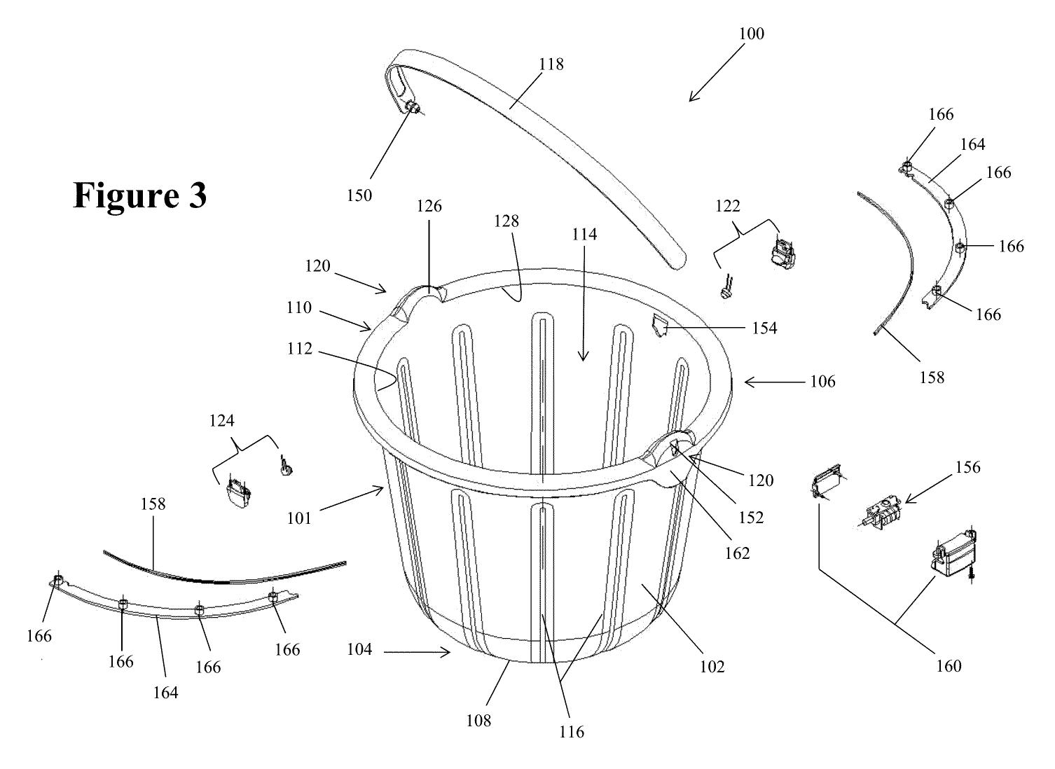

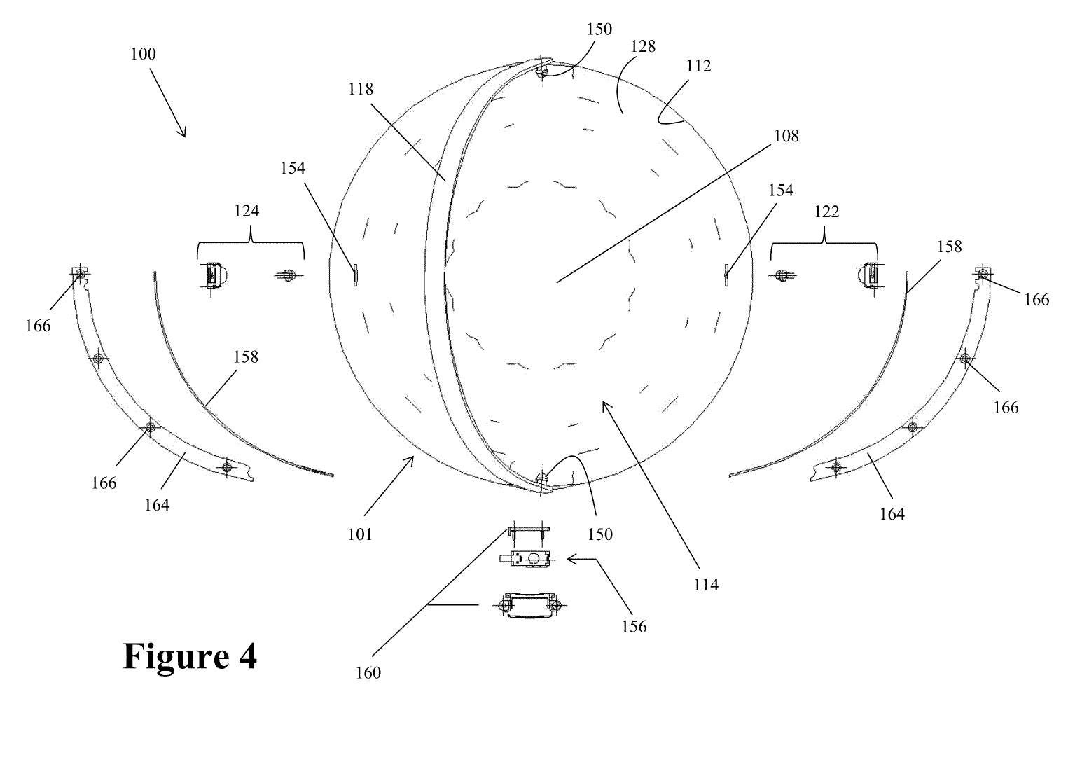

Turning now to FIGS. 3 and 4, the example illuminable receptacle 100 is shown in an exploded view. As disclosed above, in one example the handle 118 may include protrusions 150 that can be forced through apertures 152 on the attachment points 120. The protrusions 150 may be larger than the apertures 152 that receive them. After the aperture 152 is elastically deformed as the protrusions 150 are forced through the apertures 152, the smaller size of the apertures 152 retains the protrusions 150 and prevents them from backing out of the apertures 152.

As those having ordinary skill in the art will recognize, the light sources 122, 124 may be secured to the sidewall 102 of the container 101 in many different ways. FIGS. 3 and 4 show one such example, wherein the light sources 122, 124 may be secured in perforations 154 in the sidewall 102, as explained in more detail below. Each of the light sources 122, 124 may be electrically and operably coupled to a power source 156 by way of conducting wires 158. In one example, the power source 156 may be disposed in a housing 160 that can be secured behind a cover plate 162 extending downwards from the rim 110. The cover plate 162 may in some cases be formed integrally with the rim 110 and the attachment points 120. In some examples, the cover plate 162 may conceal or substantially conceal the housing 160 of the power source 156.

The conducting wires 158 may be disposed underneath the rim 110 in some examples. And to conceal the conducting wires 158 from view and to protect the conducting wires 158 from disturbance, one or more shields 164 may be used to maintain the conducting wires 158 between the shield 164 and the rim 110. The shields 164 may generally extend between the power source 156 and the light sources 122, 124. In one example, the shields 164 may include a plurality of retaining members 166 that may receive a plurality of protrusions extending downwards within the rim 110. In this example, the protrusions within the rim 110 may be snapped into or glued to the retaining members 166 of the shields 164. In some cases, the shields 164 or an underside of the rim 110 may include hooks or other means for routing the conducting wires 158 to the light sources 122, 124. That said, it should be understood that there are many ways in which to route the conducting wires 158 to the light sources 122, 124, even without the use of shields 164.

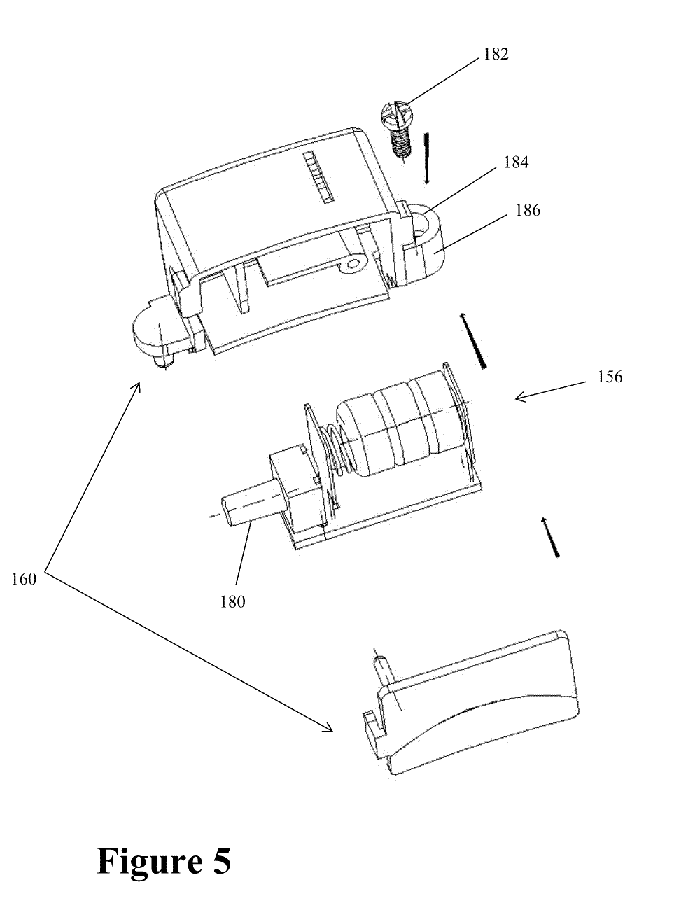

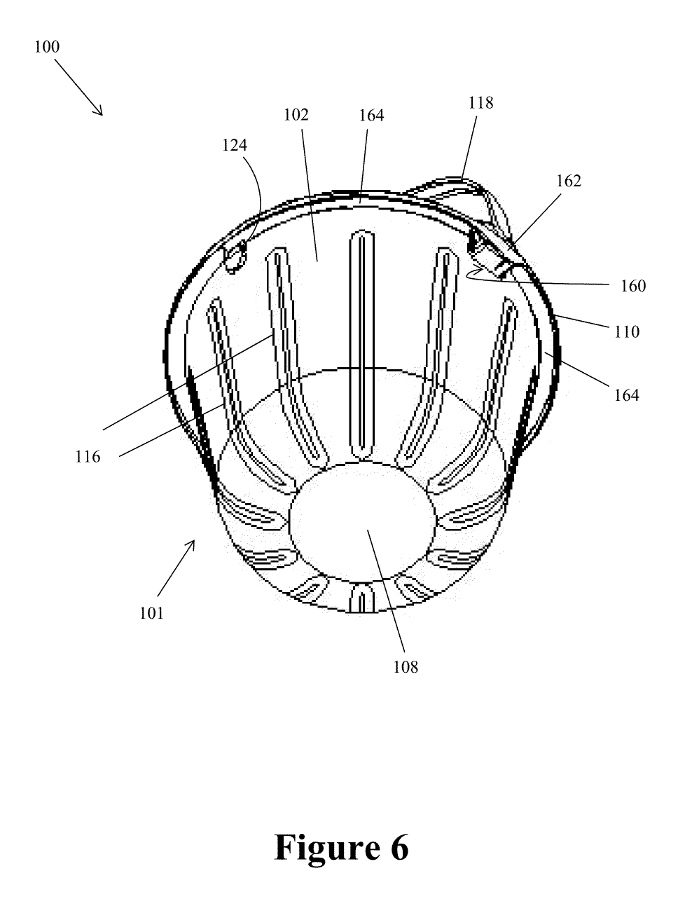

With reference to FIG. 5, power source 156 is shown in conjunction with housing 160. An example power switch 180 electrically and operably coupled to the power source 156 may control the modes of the light sources 122, 124, as explained above. In one example, the power switch 180 alters the mode of the light sources 122, 124 each time it is pushed. The power switch 180 may protrude from the housing 160 in some cases after the power source 156 has been secured within the housing 160, enabling a user of the illuminable receptacle 100 to push the power switch 180 as desired. In addition, a fastener 184 shown in FIG. 5 may be used to secure the housing 160 of the power source 156 to the rim 110, in some cases behind the cover plate 162 as shown in FIG. 6. In particular, the fastener 184 may be positioned through a hole 184 of a linkage 186 on the housing 160 and into a threaded member beneath the rim 110 capable of receiving the fastener 184.

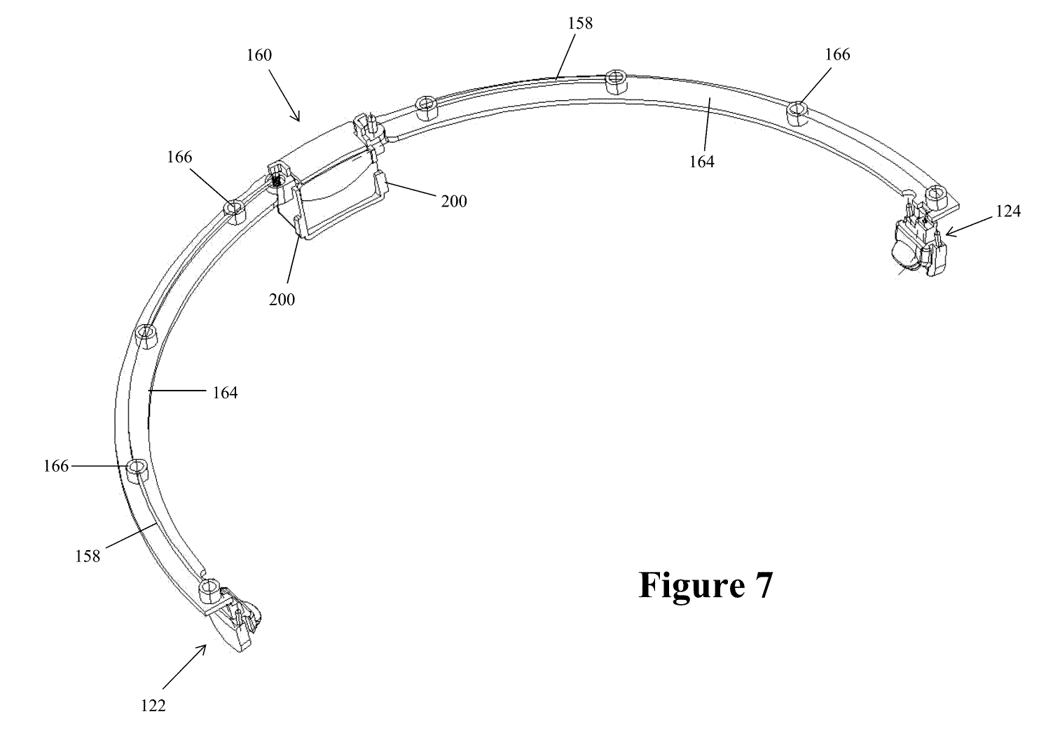

With respect to FIG. 7, example housing 160 may in some examples include one or more lips 200 that may slide into one or more tracks on the sidewall 102 behind the cover plate 162 to help locate and retain the housing 160. In addition to the housing 160, FIG. 7 shows two shields 164, conducting wires 166, first light source 122, and second light source 124 in relation to one another. In the example shields 164 shown in FIG. 7, the retaining members 166 of the shields 164 may be slotted in some examples such that the conducting wires 166 may be positioned through the slots and across the retaining members 166.

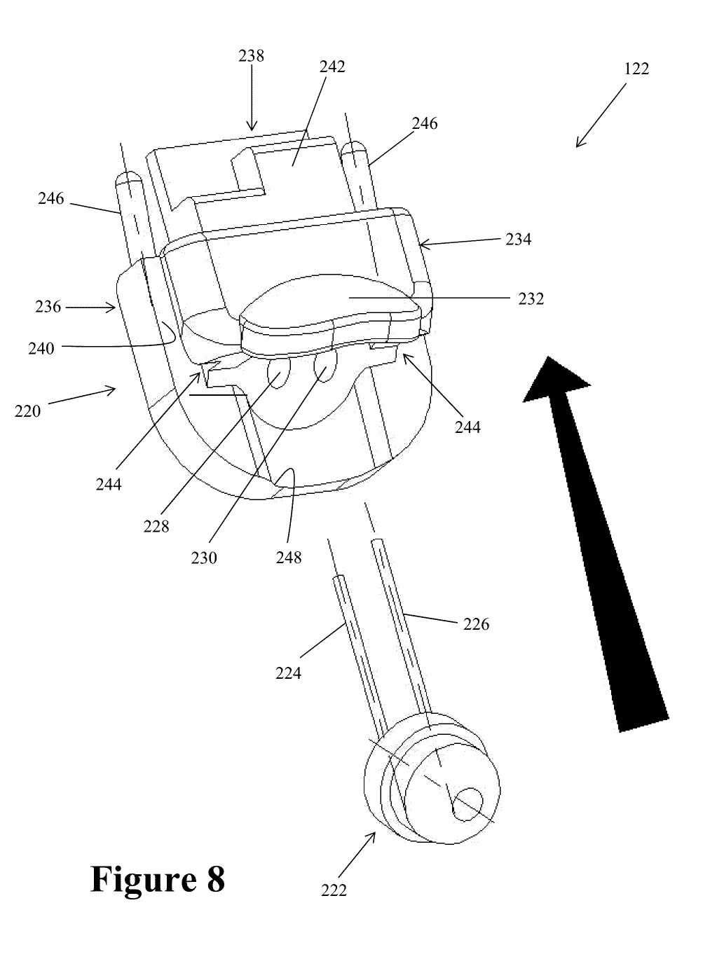

FIG. 8 shows the example light source 122 more closely. In particular, in this example the light source 122 comprises a body 220 that can receive an LED 222 or other light. Terminals 224, 226 from the LED 222 may be routed through holes 228, 230 in the body 220 and coupled to the conducting wire 158. The body 220 of the example light source 122 may include a brim 232 for protecting the LED 222 against any inadvertent contact and also for directing the light emitted from the LED 222 downwards, towards the contents of the container 101. The brim 232 may also serve to prevent light from projecting upwards into the eyes of a holder of the illuminable receptacle 100.

The body 220 of the light source 122 may be configured to mate with the perforation 154 in the sidewall 102, which can be seen in FIGS. 3 and 4. Therefore, as shown in FIG. 8, the example body 220 may include an inner portion 234, an outer portion 236, and a tab 238 projecting upwards. The inner portion 234 may be inserted through the perforation 154 in the sidewall 102 to face the inside cavity 114 of the container 101. An inner surface 240 of the outer portion 236 and an inner surface 242 of the tab 238 may rest against an outer face of the sidewall 102 once the body 220 is installed in the sidewall 102. The tab 238 may in some examples help retain the shield 164 above the light source 122 and within the rim 110.

More specifically, however, channels 244 may exist between the inner portion 234 and the outer portion 236 of the example body 220. In one example, a cross-section of the inner portion 234 may be slightly larger than a cross-section of the perforation 154 such that the inner portion 234 can pass through the perforation 154 only if the sidewall 102 around the perforation 154 slightly elastically deforms as the inner portion 234 passes through the perforation 154. After the inner portion 234 is inserted through the perforation 154, portions of the sidewall 102 adjacent to the perforation 154 may occupy the channels 244 of the body 220, securing the light source 122 in the sidewall 102. In some cases, the body 220 may include alignment features 246 to aid the placement of the light source 122 in relation to corresponding alignment features along the sidewall 102.

In the example shown in FIG. 8, the inner surface 240 of the outer portion 236 of the body 220 may include a recessed portion 248. Because in this example the inner surface 240 of the outer portion 236 of the body 220 rests against the outer face of the sidewall 102 after the light source 122 is secured to the sidewall 102, the recessed portion 248 allows a portion of the light emitted from the LED 222 to project downwards against an outer face of the sidewall 102. Thus, in this example, while the light source 122 and the LED 222 are directed downwards, primarily towards the inside cavity 114 and the base 108 of the container 101, at least a portion of the light from the LED 222 may be directed towards an outer face of the sidewall 102. Illuminating the outer face of the sidewall 102 may enhance the visibility of the container 101 and, in turn, someone carrying the illuminable receptacle 100. Furthermore, in some examples the second light source 124 may be configured in the same way as the first light source 122.

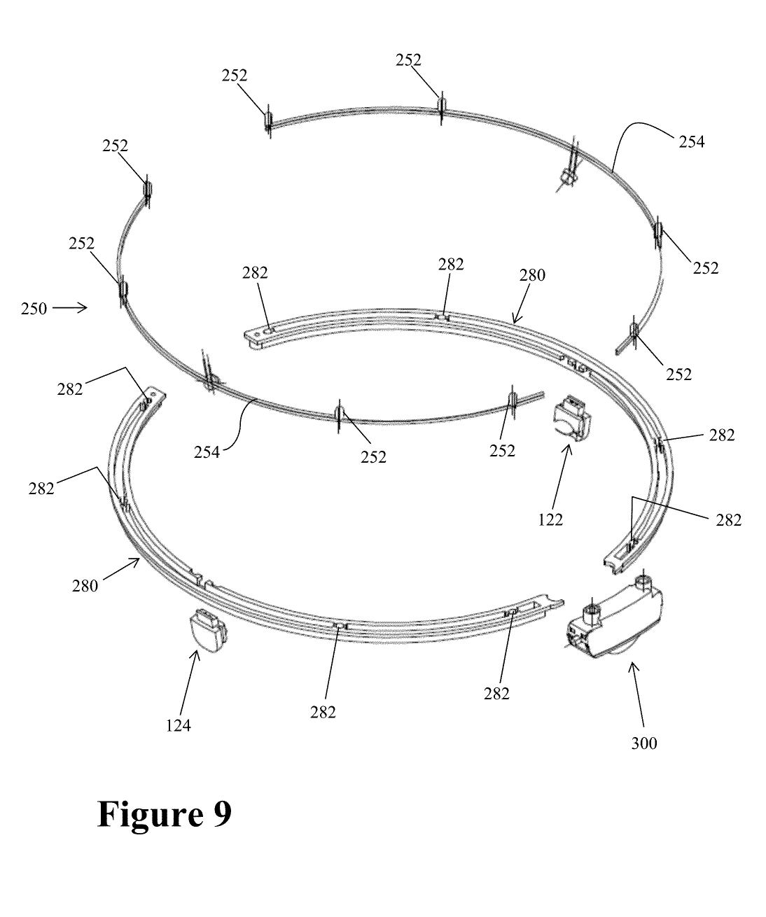

In still another example, the illuminable receptacle 100 may in some cases include a plurality of lights 250 as shown in FIG. 9 that can be positioned within or approximate the rim 110 of the container 101. Each light 252 in the plurality 250 may generally be spaced apart from one another so as to be distributed about a circumference of the rim 110. In some examples, however, the plurality of lights 250 may appear to form a continuous or virtually continuous ring of lights around the rim 110. Although the plurality of lights 250 may be tucked within or generally approximate the rim 110, the lights 250 may illuminate the rim 110 so that the rim 110 is more visible than if it were not illuminated. In some cases, the plurality of lights 250 may also illuminate a portion of the container 101 such as an upper portion of the container 101 and/or the outer face of the sidewall 102 of the container 101. Thus, the plurality of lights 250 make the receptacle 100 more visible to passerby, motorists, and others. Moreover, the lights 250 may be electrically coupled to the power source 156 by way of conducting wires. The lights 250 may be controlled by a push or deflection of the power switch 180, much like the light sources 122, 124. In some examples, the lights 250 may also be secured together by one or more pieces of plastic 254.

With continued reference to FIG. 9, additional example shields 280 are shown. While it may be possible to use the example shields 166 with the plurality of lights 250, the example shield 280 may be more suitable because the example shields 280 include slots or orifices 282 into which each light 252 may be secured. The orifices 282 could be employed in examples with or without the pieces of plastic 254. In any case, the example shields 280 may receive the light sources 122, 124 as well as snap-fit protrusions 284 extending from the pieces of plastic 254, which may help secure the plurality of lights 250 and the pieces of plastic 254 to the shields 280. In some examples, the shields 280 may include openings that allow light from the plurality of lights 250 to project downwards onto the outer face of the sidewall 102 of the container 101. Further, the shields 280 may include one or more of the features disclosed above with respect to the shields 164 in FIGS. 3, 4, 7. Conversely, the shields 164 in FIGS. 3, 4, 7 may be modified to include one or more of the features disclosed here with respect to the example shields 280 of FIG. 9.

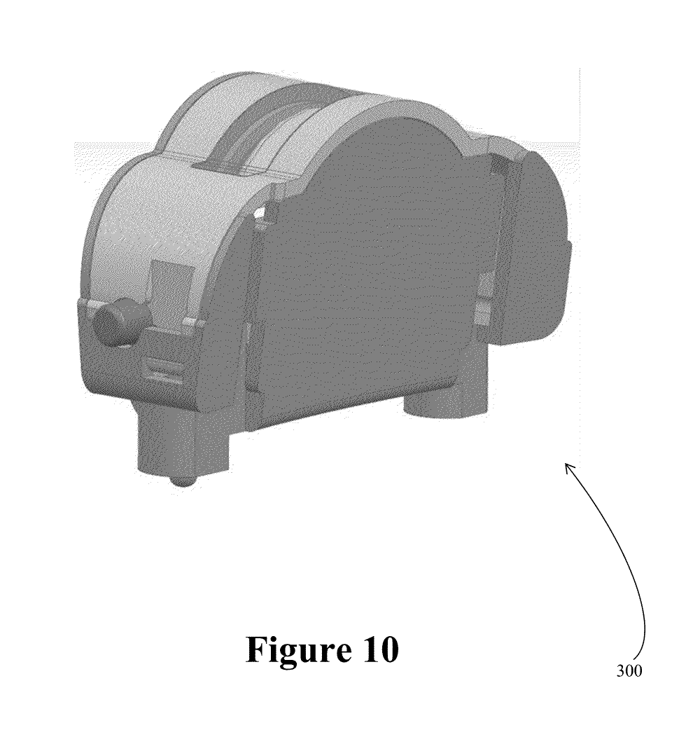

FIG. 9 also shows another example housing 300 for a power source. In this example, the housing 300 for a power source is larger than the example housing 160 shown in FIGS. 3-7. With the ability to contain a larger battery, for example, the housing 300 is more appropriate in cases where the light sources 122, 124 must stay on longer and/or where the battery provides power to both the light sources 122, 124 and the plurality of lights 250. The example housing 300 is also shown more closely in FIG. 10. Further to that end, it should be understood that the illuminable receptacle 100 may include two or more power sources in some examples.

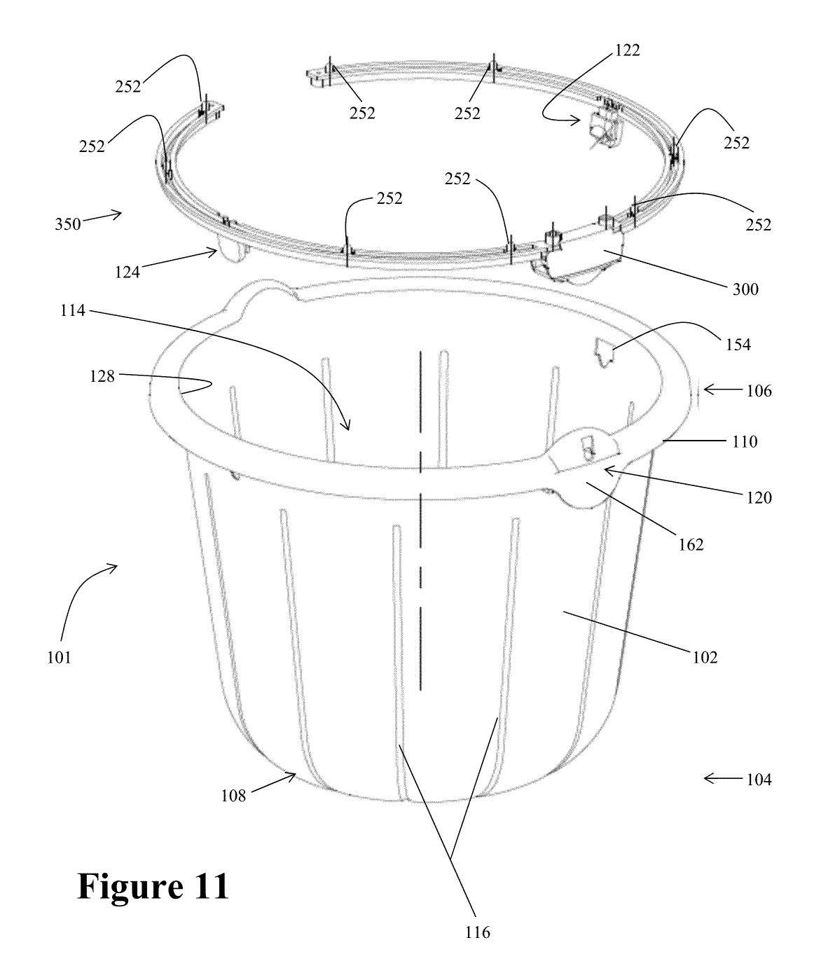

FIG. 11 shows in the context of the container 101 a subassembly 350 comprising the plurality of lights 250, the example shields 280, and the example housing 300. Those having ordinary skill in the art will recognize how the subassembly 350 may be secured generally underneath the rim 110 and the cover plate 162 of the container 101. Likewise, those having ordinary skill in the art will understand that it is possible to operate the light sources 122, 124 and the plurality of lights 250 underneath the rim 110 in a number of different modes. For example, in one mode both the light sources 122, 124 and the plurality of lights 250 may be illuminated. In another mode, only the plurality of lights 250 may be illuminated. In still another mode, only the light sources 122, 124 may be illuminated.

As those having ordinary skill in the art will recognize, these components of the example illuminable receptacle 100 may come in a wide variety of shapes and sizes without departing from the scope of the present disclosure. Likewise, those having ordinary skill in the art will understand that in some examples, an illuminable receptacle will not necessarily have all of these components. Those having ordinary skill in the art will further understand that in other examples, an illuminable receptacle may have additional components. Accordingly, even though certain example apparatuses have been described herein, the scope of coverage of this patent is not limited thereto. On the contrary, this patent covers all methods, apparatus, and articles of manufacture fairly falling within the scope of the appended claims either literally or under the doctrine of equivalents.

I claim:

1. An illuminable receptacle comprising:
a container having a sidewall that is single-layered and extends between a lower end and an upper end of the container, the container having a base disposed towards the lower end and an opening disposed approximate the upper end that provides access to an inside cavity of the container;
a handle secured to the upper end of the container;
a first light source secured to the sidewall at a first location that is closer to the upper end of the container than to the lower end of the container, wherein the first light source includes a first light that is configured to emit light inwards towards the inside cavity and downwards towards the base of the container;
a power source electrically coupled to the first light for supplying power to the light source; and
a power switch for turning the first light on and off.

2. The illuminable receptacle of claim 1, further comprising a second light source secured to the sidewall at a second location that is closer to the upper end of the container than to the lower end of the container, wherein the second light source includes a second light that is configured to emit light downwards towards the inside cavity and the base of the container.

3. The illuminable receptacle of claim 2, wherein the second location of the second light source is generally opposite the first location of the first light source in relation to the container.

4. The illuminable receptacle of claim 3, wherein the first and second light sources are substantially flush with an inner face of the sidewall so as not to obstruct access to the inside cavity of the container.

5. The illuminable receptacle of claim 1, further comprising a cover plate extending downwards from a rim disposed at the opening, wherein the power source is disposed behind the cover plate and is concealed or substantially concealed by the cover plate.

6. The illuminable receptacle of claim 5, further comprising:
a conducting wire used to couple the power source to the first light of the first light source, the conducting wire positioned approximate the rim of the container; and
a shield disposed within at least a portion of the rim, the shield for concealing the conducting wire and protecting the conducting wire from disturbance, the shield generally extending between the power source and the first light source.

7. The illuminable receptacle of claim 1, wherein the first light source is secured in a perforation in the sidewall.

8. The illuminable receptacle of claim 7, wherein the first light source comprises an inner portion, an outer portion, and a brim, wherein the inner portion is positioned inwards of the sidewall and the outer portion is positioned outwards of the sidewall, wherein the brim helps protect the first light, helps direct light from the first light downwards toward the base and the inside cavity of the container, and helps reduce an amount of light that projects upwards from the first light.

9. The illuminable receptacle of claim 7, wherein the first light source is secured in the perforation in the sidewall in a way such that a portion of the light emitted from the first light illuminates an outer face of the sidewall.

10. The illuminable receptacle of claim 1, further comprising:
a rim disposed at the upper end of the container; and
a plurality of lights positioned approximate the rim.

11. An illuminable receptacle comprising:
a plastic container having a lower end, an upper end, a single-layered sidewall extending between the lower end and the upper end, a base disposed towards the lower end, an opening disposed approximate the upper end that provides access to an inside cavity of the plastic container;
a handle secured to the plastic container at at least two attachment points; and
a light source secured to the single-layered sidewall at a location that is closer to the upper end of the plastic container than to the lower end of the plastic container, wherein the light source includes a light that is configured to illuminate at least the base of the plastic container or any contents of the plastic container that are supported by the base.

12. The illuminable receptacle of claim 11, wherein the light is configured to emit light primarily inwards towards the inside cavity of the plastic container and downwards towards the base of the plastic container.

13. The illuminable receptacle of claim 12, further comprising:
a power source for providing power to the light;
a power switch for controlling when power is provided from the power source to the light; and
a plurality of lights positioned approximate a rim of the container, wherein the plurality of lights are electrically coupled to the power source.

14. The illuminable receptacle of claim 13, further comprising a cover plate extending from a rim disposed at the opening, the cover plate extending from the rim beneath one of the at least two attachment points, wherein the power source is disposed behind the cover plate and is concealed or substantially concealed by the cover plate.

15. The illuminable receptacle of claim 13, further comprising:
a conducting wire used to couple the power source to the light of the light source, the conducting wire positioned approximate the rim of the plastic container; and
a shield disposed within at least a portion of the rim and extending between the power source and the light source, the shield for concealing the conducting wire, protecting the conducting wire from disturbance, and supporting the plurality of lights positioned approximate the rim.

16. The illuminable receptacle of claim 12, wherein the light source is substantially flush with an inner face of the single-layered sidewall.

17. The illuminable receptacle of claim 12, wherein the light source comprises an inner portion and an outer portion, wherein the light source is secured to the single-layered sidewall at a perforation in the single-layered sidewall such that the inner portion is positioned inwards of the single-layered sidewall and the outer portion is positioned outwards of the single-layered sidewall.

18. The illuminable receptacle of claim 17, wherein a cross-section of the inner portion of the light source is larger than a cross-section of the perforation in the single-layered sidewall.

19. An illuminable receptacle comprising:
a container having a sidewall that is single-layered and extends between a lower end and an upper end of the container, the container having a base disposed towards the lower end and an opening disposed approximate the upper end that provides access to an inside cavity of the container;
a first light source secured to the sidewall at a first location that is closer to the upper end of the container than to the lower end of the container, wherein the first light source includes a first light that emits light primarily inwards towards the inside cavity of the container and downwards towards the base of the container;
a second light source secured to the sidewall at a second location that is closer to the upper end of the container than to the lower end of the container, wherein the second light source includes a second light that emits light primarily inwards towards the inside cavity of the container and downwards towards the base of the container;
a power source for supplying power to the first and second lights;
conducting wires for coupling the power source to the first and second lights; and
a power switch for turning the first and second lights on and off.

20. The illuminable receptacle of claim 19, wherein the first and second light sources are substantially flush with an inner face of the sidewall so as not to obstruct access to the inside cavity of the container.

21. The illuminable receptacle of claim 19, further comprising:
a cover plate extending from a rim disposed at the opening at the upper end of the container, wherein the power source is disposed behind the cover plate and is concealed or substantially concealed by the cover plate; and
at least one shield disposed within at least a portion of the rim, the shield for concealing and protecting at least one of the conducting wires as well as for supporting a plurality of lights disposed approximate the rim.
